(19) United States
(12) Patent Application Publication
(10) Pub. No.: US 2022/0132000 A1
(43) Pub. Date: Apr. 28, 2022

(54) COLOR SPACE CONVERSION

(71) Applicant: Hewlett-Packard Development Company, L.P., Spring, TX (US)

(72) Inventors: Carlos Fajardo Sanchez, Sant Cugat del Valles (ES); Joan Vidal Fortia, Sant Cugat del Valles (ES); Ivan Perez Laka, Sant Cugat del Valles (ES)

(73) Assignee: Hewlett-Packard Development Company, L.P., Spring, TX (US)

(21) Appl. No.: 17/417,708

(22) PCT Filed: Jul. 10, 2019
(86) PCT No.: PCT/US2019/041196

§ 371 Date: Jun. 23, 2021

(51) Int. Cl. H04N 1/60

(52) U.S. Cl. CPC H04N 1/6058

(57) ABSTRACT

Certain examples relate to converting between color spaces. A digital representation of an input color is pre-processed to convert the digital representation into a multidimensional node representing a region in the input color space and a set of adjustment values. The multidimensional node is mapped to a digital representation of an output color. The digital representation of the output color is adjusted using the set of adjustment values.

### BACKGROUND

Colors defined in an input color space, for example a Red, Green, Blue (RGB) color space, may be converted to colors defined in an output color space, for example Cyan, Magenta, Yellow, BlacK (CMYK). Converting a color from one color space to another color space may be used to generate data which can be used for display or printing applications. For example, where image data comprises color information defined in an RGB color space, the image data may be converted to a CMYK color space for printing using a printer having a CMYK ink set. Colors may be defined in a color space using multidimensional variables, each of which may correspond to a color channel in the color space. The multidimensional variables may specify proportions or amounts of each color channel which are used to represent the color.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram illustrating an apparatus for converting between color spaces according to an example;

FIG. 2 is a table for use in converting an input color channel value to a node element value according to an example;

FIG. 3 is schematic diagram illustrating an apparatus for converting between color spaces according to an example;

FIG. 4 is a graph illustrating a plurality of mappings between input color channel values and node element values according to examples;

FIG. 5 is a flow diagram of a method for converting between color spaces according to an example;

FIG. 6 is a schematic diagram illustrating a distribution of regions in an input color space defined by two color channels; and

FIG. 7 is a schematic diagram illustrating a non-transitory computer-readable storage medium according to an example.

### DETAILED DESCRIPTION

Color can be represented within print and display devices in a large variety of ways. For example, in one case, a color as observed visually by an observer may be defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of people. These categories can then be modelled using a lower number of variables.

Within this context, a color model may define a color space. A color space in this sense may be defined as a multi-dimensional space, with a point in the multi-dimensional space representing a color value and dimensions of the space representing variables within the color model. For example, in a Red, Green, Blue (RGB) color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. These values may then be mapped to output states of a rendering device, such as light emitting diodes of a display screen. Other color spaces include: a Cyan, Magenta, Yellow and Black (CMYK) color space, in which four variables are used in a subtractive color model to represent different quantities of colorant (or printing fluid, e.g. for a printing system); the International Commission on Illumination (CIE) 1931 XYZ color space, in which three variables (‘X’, ‘Y’ and ‘Z’ or ‘tristimulus values’) are used to model a color; the CIE 1976 (L*, a*, b*-CIELAB or ‘LAB’) color space, in which three variables represent lightness (‘L’) and opposing color dimensions (‘a’ and ‘b’); and the YUV color space, in which three variables represent the luminance (‘Y’) and two chrominance dimensions (U and V). In the following description reference is made to “color channels”. The term “color” in this respect is used broadly to relate to any visual property and may include lightness information as well as opponent color definitions. For example, it will be appreciated that in the L*, a*, b* color space, each of the three variables may be said to correspond to a respective “color channel”. Similarly, for the YUV color space, each of Y, U, and V may be said to be a “color channel”.

Image data, e.g. representing an image to be output by an imaging system, may comprise color data represented in a first color space, such as image-level pixel representations in an RGB color space. In an imaging pipeline, e.g. a printing pipeline in examples where the imaging device is a printing device, a color separation process may be used to map from the image color space to a second color space for use in outputting an image, e.g. in a printing process. For example, the imaging system may be associated with a color space, e.g. a colorant color space defined by colorants available to the imaging system for outputting an image. In examples, the imaging system comprises an imaging controller to output a signal to an imaging device, e.g. an electronic visual display or projector. The imaging controller may be implemented using machine readable instructions and/or suitably programmed or configured hardware, e.g. circuitry. In these examples, the color space associated with the imaging system may be defined by color channels (i.e. colorants) available to the imaging device. In other examples, the imaging system comprises a printing system, and the colorant color space may therefore be defined by colorants available to the printing system for deposition or application to a print target.

Converting from a first color space to a second color space may comprise using a lookup-table (LUT) which comprises entries which associate input colors defined in the first color space, to respective output colors defined in the second color space. The first color space and the second color space may also be called an input color space and an output color space respectively. LUTs may be used to increase the speed and efficiency of the process of converting from the first color space to the second color space as it negates the need to perform a complex calculation each time a color is to be converted. However, LUTs used to convert from a first color space to a second color space may store entries corresponding to a subset of the available colors which can be represented in either the first or second color spaces.

For example, in a case where the first color space is an RGB color space, a digital representation of a color in the RGB color space may comprise three 8-bit values, each 8-bit value representing an amount of a respective color channel (R, G, or B) that is used to define the color. Each 8-bit value may represent any integer value from 0-255. In this case, three 8-bit values defining each color in the RGB color space lead to 256³ (or 16,777,216) possible colors which can be represented. Consequently, if the LUT were to include a conversion for each color then the LUT may be prohibitively large (e.g. with respect to limited hardware resources of an imaging device) and would take longer periods of time to access (e.g. periods of time that are greater than a desired imaging refresh rate). Hence, it is desirable for LUTs to be large enough to provide desired color space conversion resolution while also being efficient to access.

According to examples, an input color space may be divided into a plurality of regions of equal size. For example, each channel in an RGB color space may be divided into 2^{N} (e.g. 8, 16, 32, etc.) regions of equal size. In an example where each color channel is divided into 8 regions, there may be 9³ nodes which bound the regions (e.g. 8+1 nodes to include nodes that bound the region and where each region falls between two nodes), and 8³ regions in the input color space. In these cases, the LUT may comprise conversion data relating to the 9³ nodes which define the regions.

In the cases above, digital representations of colors in the input color space may be processed using bit-shifting to obtain values for nodes defined in the LUT and hence perform a conversion. However, by using bit-shifting to access the LUT, the size of the LUTs which can be used are constrained by the conditions above i.e. each color channel may be split into 2^{N} equally sized regions. Where color space conversion is performed as part of an image processing pipeline, or print processing pipeline, the available resources may be low. Consequently, it may not be possible to increase the resolution of the color space conversion depending on available hardware. For example, where an input color space comprises three color channels, and each color channel is divided into 16 regions (i.e. N=4), a LUT comprising data corresponding to a color space conversion will comprise 17³ entries. To increase the resolution, it may be possible to divide each color channel into 32 regions (i.e. with N+1=5) resulting in 33³ entries in the LUT. However, this corresponds to a large increase in memory usage for storing the LUT. In other examples, such as where the input color space comprises four color channels, each color channel may be initially divided into fewer regions, such as 8 (i.e. N=3) due to the memory constraints, resulting in 9⁴ entries in the LUT. In this case, increasing the resolution may involve increasing the number of regions to 16 (i.e. N+1=4) and so resulting in 17⁴ entries in the LUT.

It may be more desirable to increase the resolution by only a small amount or only in certain regions of the input or output color space. Further, with the development of printing systems having a larger number of colorants than a simply CMYK printing system, including fluorescent colorants and/or other colors such as green and violet, increasing the resolution of color space conversion is desirable such that accurate representations of images can be produced using such printing systems.

Accordingly, certain examples described herein relate to pre-processing input color representations such that a LUT table may have any desired number of entries that can be used to convert the input color to an output color. This may allow the resolution of the color space conversion to be increased by desired amounts within the constraints of available hardware. Certain examples described herein may allow the input color space to be divided into non-uniformly sized regions, thereby allowing greater memory efficiency and increased color space conversion resolution in desired regions of the input or output color space.

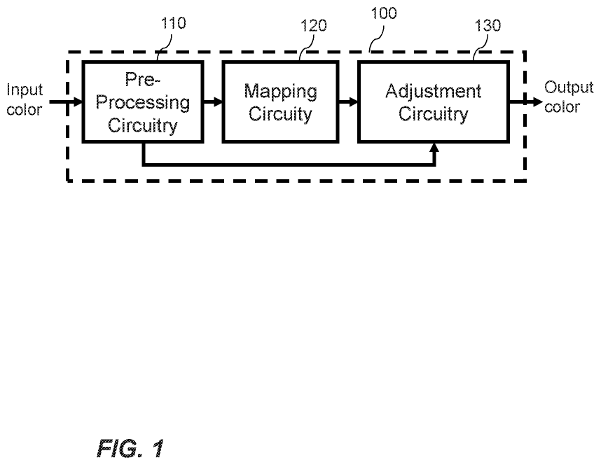

FIG. 1 is a schematic diagram illustrating an apparatus 100 for converting between color spaces. The apparatus 100 may be a part of a larger imaging system. For example, the apparatus 100 may be part of a printing system in which input data representing an image is converted to print data, which is then used to generate a physical representation of the image using a print engine. Colors in the input data may be defined in an input color space, for example an RGB color space corresponding to a digital display of a computer used to generate said input data. Colors in the print data may be defined in an output color space, for example a CMYK color space corresponding to available colorants in the print engine. In other examples, the printing system may be a three-dimensional printing system in which model data is used to generate a three-dimensional object by available additive manufacturing techniques.

In some examples, such as where the apparatus 100 is part of a printing system, the apparatus 100 may be hardware specifically designed to perform the functions described herein. For example, the apparatus 100 may be an application specific integrated circuit (ASIC), or alternatively the apparatus 100 may be a suitably programmed field programmable gate array (FPGA). The apparatus 100 may include a plurality of ASICs or FPGAs. In other examples, the apparatus 100 may be a general computing device comprising at least one memory and at least one processor configured to perform the functions described herein. The apparatus 100 may be communicatively coupled to any number of external devices including imaging sensors, display devices, and other suitable computing devices.

The apparatus 100 comprises pre-processing circuitry 110 to convert a digital representation of an input color in an input color space to a node representing a region in the input color space and a set of adjustment values. The set of adjustment values represent a location within the region. As discussed above, a color may be represented digitally by a multidimensional variable, for example three 8-bit values may be used to represent a color in the RGB color space. The digital representation of the input color may comprise a plurality of n-bit values, wherein each n-bit value may be referred to as input color channel value. The node may be a multidimensional node. For example, the node may comprise a plurality of node element values. The node element values may each correspond to a color channel of the input color space. As discussed above, a digital representation of a color may comprise a plurality of n-bit values, for example 8-bit values. Where the input color space is an RGB color space, a digital representation may comprise three 8-bit values of the form (R,G,B) wherein each variable represents an integer between 0 and 255 and each variable represents a different color channel. Where the input color space is a CMYK color space, the digital representation of the input color may comprise four 8-bit variables, each being an integer value between 0 and 255.

In the present example, the input color space is divided into a plurality of regions, wherein each region includes a plurality of colors defined in the input color space. By representing each region by a single multidimensional node, the input color space may be effectively sub-sampled. For example, in an 8-bit system having a range of 256 integer values, each node may be identified by one of 10 integer values. However, by maintaining the set of adjustment values, information relating to the input color's precise location in the input color space may also be maintained. The multidimensional node may comprise a plurality of values each of which correspond to a respective color channel in the input color space. The multidimensional node may be represented digitally by a plurality of n-bit values. For example, the multidimensional node may be represented in the form (x, y, z) wherein x, y, and z each correspond to a region in their respective color channels and the multidimensional node (x, y, z) corresponds to a region in the input color space. In one case, each node may correspond to a start or end of a region. In this case, N regions may be defined with N+1 nodes. Whether a given node falls within or outside of a region (e.g. whether a bin start or end is open or closed) may be configured according to particular implementations. In another case, each node may define a center-point of a region.

The apparatus 100 comprises mapping circuitry 120 to map the multidimensional node to a digital representation of an output color in an output color space. The apparatus 100 also comprises adjustment circuitry 130 communicatively coupled to the pre-processing circuitry 110 and the mapping circuitry 120 to adjust the digital representation of the output color using the set of adjustment values. As the input to the mapping circuitry 120, i.e. the multidimensional node, has fewer possible values than the number of available input color channel values, a process used to map from the node to the digital representation of the output color may be simplified. Consequently, bit-shifting may not be used and so the mapping circuitry may be more configurable and so may be used in a more efficient manner.

Pre-processing the digital representation of the input color to a multidimensional node may simplify the mapping performed by the mapping circuitry 120. In some examples, the mapping circuitry 120 implements a lookup-table comprising entries associating multidimensional nodes representing regions in the input color space with respective digital representations of output colors in the output color space. The mapping performed by the mapping circuitry 120 may comprise identifying, or selecting, an entry in the lookup-table corresponding to the multidimensional node and outputting the corresponding digital representation of the output color in an output color space corresponding to that multidimensional node. Consequently, the multidimensional node may be mapped to a digital representation of an output color using a simple lookup function rather than performing further processing of the multidimensional node when using the lookup-table. This allows the lookup-table to be implemented with a desired number of entries rather than having enough entries to represent 2^{N} regions. Previously, input color channel values of the digital representation of the input color were bit-shifted to identify an entry (or entries) in the lookup-table which were to be used to generate digital representations of output colors. Consequently, the way in which the input color space was divided, and the number of entries in the LUT, was constrained to particular values.

In an example, the digital representation of the input color comprises a plurality of input color channel values, and pre-processing is performed per input color channel such that the multidimensional node comprises a respective plurality of node element values. Performing the pre-processing per input color channel may allow the regions into which the input color space is divided to have different sizes in some or each of the color channels. This may make it possible to configure the color space conversion to be more or less sensitive in different color channels. The way in which the pre-processing is performed for all color channels or for each color channel may be selected based on hardware resources, such as memory and processing resources. The way in which the pre-processing is performed for all color channels or for each color channel may also be dependent upon a desired accuracy of color space conversion for each color channel. Performing the pre-processing per input color channel may also make it possible to concurrently process different input color channel values corresponding to a single digital representation of an input color.

In some examples, the pre-processing circuitry 110 implements a lookup-table per input color channel to map from a respective input color channel value to one or more of a corresponding node element value and a corresponding adjustment value. The lookup-tables for mapping from respective input color channel values to corresponding node element values and corresponding adjustment values may be generated and stored in the pre-processing circuitry ahead of the pre-processing circuitry performing the conversion. For example, the lookup-tables may be generated with entries which divide the input color space into a desired number of regions with a desired resolution in each region. In some examples, the pre-processing circuitry 110 may implement more than one lookup-table per input color channel.

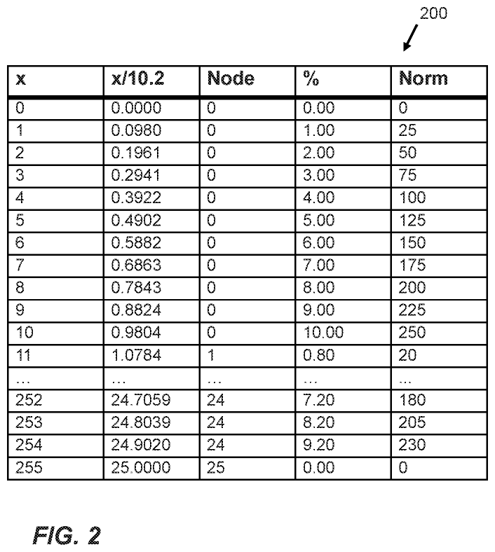

FIG. 2 illustrates a part of a lookup-table 200 for use in converting an input color channel value to a node element value. The table 200 shown in FIG. 2 may be used to pre-process input color channel values from one color channel or may be a general table for use in pre-processing input color channel values from any number of color channels. The first column, ‘x’, represents the input color channel values. In the example shown in FIG. 2, the digital representation of the input color channel value is an 8-bit value and hence the input color channel values are integer values between 0 and 255. It is to be appreciated that the table 200 shown in FIG. 2 is representative of a larger table comprising 256 entries corresponding to one entry per possible input color channel value. A subset of the total number of entries is shown in the table 200 of FIG. 2 for clarity.

In the example shown in FIG. 2, the input color space is divided into 25 regions, which corresponds to 26 node element values (one per region plus a final node element value for color channel values falling outside of this range). The second column, “x/10.2”, corresponds to a result of a division between the respective input color channel value, “x”, and a divisor. The divisor, in this case 10.2, is determined as a scaling factor between the maximum input color channel values, 255, and the number of available regions, in this case 25, and so the divisor may be determined as 255/25=10.2. The result of the division, “x/10.2”, is rounded to identify the relevant node for each input color channel value. The third column, “Node”, identifies the respective nodes to which each of the input color channel values relate, this is determined by taking an integer value from the “x/10.2” column. The forth column, “%”, represents how close the respective input color channel value is to the next node, this may be referred to as a remainder. The values in the fourth column may be determined based on a modulo function using the input color channel value and a modulo factor. The modulo factor in this case being 10.2. The fifth column, “Norm”, comprises a normalized version of the remainder shown in the fourth column, in which the remainder values have been normalized to 0-255. These normalized remainder values may be referred to as the adjustment values, in other examples the values from the fourth column “%” may be referred to as the adjustment vales. The lookup-table 200 may be populated for every possible input color channel value ahead of the pre-processing such that no division is performed during the pre-processing. In this case, the lookup-table 200 is simply accessed and a node and adjustment factor are determined for a given input color channel value.

As discussed above, the pre-processing may be performed per color channel. For example, there may be a plurality of lookup-tables, including at least one lookup-table per color channel. In this way it may be possible to concurrently pre-process input color channel values relating to different color channels. This may increase the throughput of the color space conversion.

In some examples, pre-processing an input color channel value comprises using a rounded division of the input color channel value with a divisor. The divisor may be based on a number of available regions and a maximum input color channel value. For example, the divisor may represent a scaling factor relating the number of available input color channel values (e.g. as represented by a maximum available value) and the number of available regions in the input color space. The pre-processing may also comprise using a modulo function based on the input color channel value and a modulo factor. The modulo factor may be based on the number of available regions and the maximum input color channel value. For example, the modulo factor may represent the scaling factor relating the number of available input color channel values (e.g. as represented by the maximum available value) and the number of available regions in the input color space.

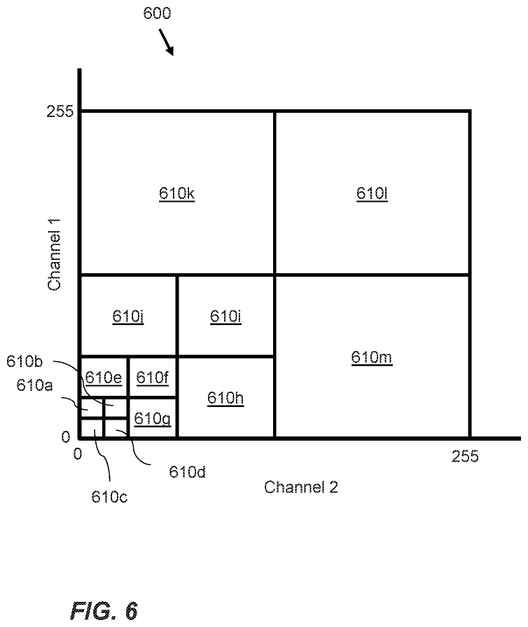

In the example shown in FIG. 2, the input color space has been divided into 25 equally sized regions. However, the input color space may be divided into any desirable number of regions. Generally, having a larger number of regions may provide more accurate conversion of input colors to output colors. However, this may come at the cost of increased memory usage and slower access to the lookup-table. Additionally, or alternatively, the input color space may be divided into a plurality of regions where the size of at last some of the regions are different. This will be discussed further later in relation to FIG. 6.

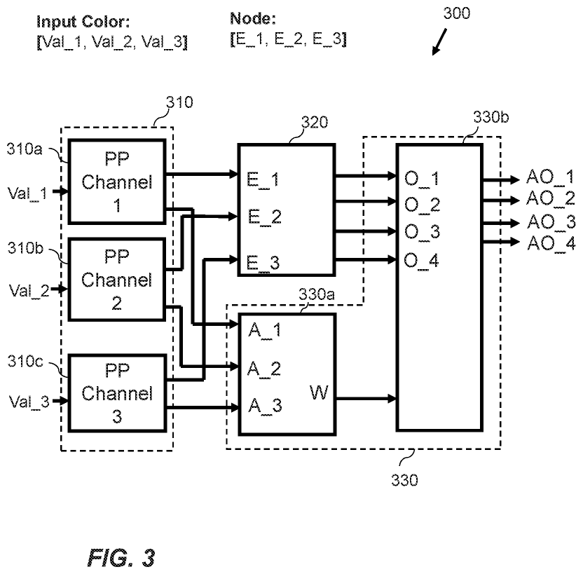

FIG. 3 is schematic diagram illustrating an apparatus 300 for converting between color spaces according to another example. The apparatus 300 shown in FIG. 3 may comprise one possible implementation of the apparatus 100 shown in FIG. 1, wherein other possible implementations may be available as described above.

The apparatus 300 comprises pre-processing circuitry 310. The pre-processing circuitry 310 comprises three components 310a, 310b, and 310c. Each component is used to process a respective input color channel value, wherein the digital representation of the input color comprises three input color channel values Val_1, Val_2, Val_3. Each component 310a, 310b, 310c may implement a lookup-table (e.g. similar manner to that shown in FIG. 2) to convert the respective input color channel values to node element values and adjustment values. In this case, the plurality of node element values, shown in FIG. 3 as E_1, E_2, E_3, represent different elements or dimensions of a multidimensional node. The number of available node element values may be fewer than the number of available input color channel values. For example, the input color channel values may be stored, or represented, using 8-bit values, whereas the node element values may be represented as 4 or 6-bit values. In other examples, the input color channel values and the node element values are represented using the same number of bits, but the node element values are restricted to specific values. For example, the input color channel values may be any integer value between 0-255, whereas the node element values may be an integer value between 0-255 but only a subset of the range 0-255 may be usable, for example, every sixteenth value in the range 0-255.

The adjustment values are shown in FIG. 3 as A_1, A_2, A_3. The apparatus 300 comprises mapping circuitry 320. The mapping circuitry 320 is used to map the multidimensional node, comprising node element values E_1, E_2, E_3 to a digital representation of an output color in the output color space. In the example shown in FIG. 3, the multidimensional node [E_1, E_2, E_3] is mapped to a digital representation of an output color comprising output color channel values O_1, O_2, O_3, O_4.

In the example shown in FIG. 3, the color space conversion converts from an input color space comprising three color channels to an output color space comprising four color channels. However, it is noted that the input color space and the output color space may have any suitable number of respective color channels. In some examples, the input and the output color space may have the same number of color channels. The number of color channels which are present in the input and/or the output color spaces may be dependent on the way in which the respective color space is defined. For example, RGB has a suitable number of color channels corresponding to a number of color channels available in electronic displays comprising a plurality of pixels. Similarly, CMYK has a suitable number of color channels corresponding to a number of available colorants in an example printing system.

The apparatus 300 comprises adjustment circuitry 330 communicatively coupled to the pre-processing circuitry 310 and the mapping circuitry 320 to adjust the digital representation of the output color [O_1, O_2, O_3, O_4] using the set of adjustment values [A_1, A_2, A_3]. Via component 330a, at least one weight, W, may be calculated based on the adjustment values. Via component 330b, the at least one weight W may be used to adjust the output color channel values, O_1, O_2, O_3, and O_4, to generate adjusted output color channel values AO_1, AO_2, AO_3, and AO_4 representing an output color in the output color space. Adjusting the output color channel value may comprise performing an interpolation using the digital representation of the output color, to which the multidimensional node is mapped, and digital representations of neighboring output colors in the output color space.

As discussed above, pre-processing digital representations of input colors may allow a mapping to an output color space to be performed using a simple lookup-function. This may remove some of the constraints on the form of lookup-tables used in the mapping or the division of the input color space into 2^{N} regions. Hence, the lookup-table may have greater customizability and so can be configured to utilize hardware resources more efficiently.

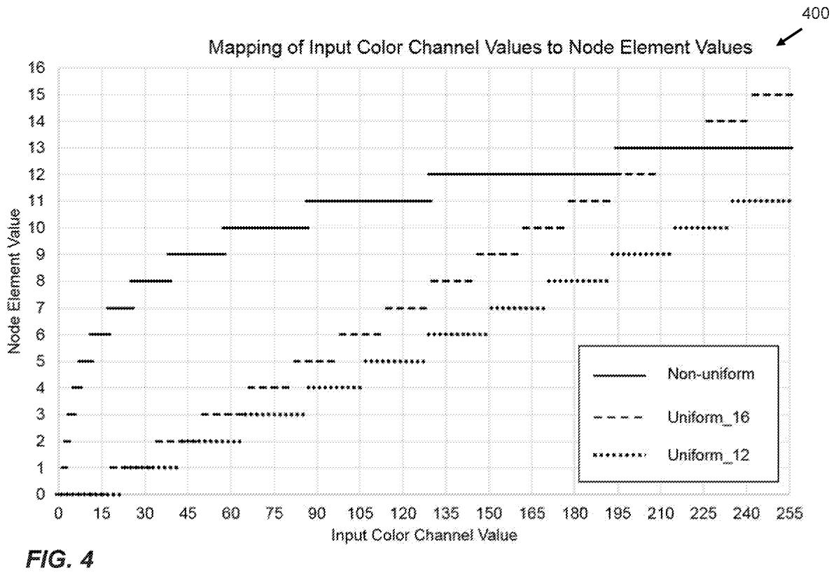

FIG. 4 is a graph 400 illustrating how the input color channel values for an input color channel may be mapped to node element values. According to a first implementation, the input color channel values may be divided into 16 regions of equal size, this is shown by the data which is represented using broken lines. In this first implementation, the first sixteen available input color values are each mapped to a first node element value, 0. The second sixteen available input color values (16-31) are mapped to the second node element value, 1. This logic is applied to the entire range of available input color channel values such that each node is mapped to 16 input color channel values. Mapping the input color channel 0 and 255 to a node element may be trivial as these represent the minimum and maximum values, and so in some cases one or both of these values may not be factored into the mapping or may dealt separately from the rest of the input color channel values. Where the input color channel value is used to directly access a lookup-table suitable for mapping an input color to an output color, the input color channel value needs to be processed, for example, by bit-shifting, and hence the lookup-table may be constrained to having entries corresponding to 2^{N} regions. In the present disclosure, as the input color channel values are pre-processed it is possible for the input color space to be divided into any desirable number of regions, for example 12 regions. The second implementation shown in FIG. 4 using dotted lines, shows the input color channel values divided into 12 equally sizes regions, each being associated with a respective node element value.

In some examples, the input color space may be divided into regions of different sizes. For example, the number of input color channel values which are mapped to each node element value may not be the same for every node element value. In FIG. 4, the third implementation, represented using solid lines, shows the input color channel values being divided into regions of different sizes. In this example, the regions follow a logarithmic distribution. This may allow the color space conversion to have higher accuracy and/or precision in desired regions of the input color space. The human visual system is generally more sensitive to differences in color in brighter regions of an image and is less sensitive to differences in color in darker regions. Consequently, it may be desirable to increase the color space conversion resolution in brighter parts of the input color space at the cost of decreasing the color space conversion resolution in darker parts of the input color space.

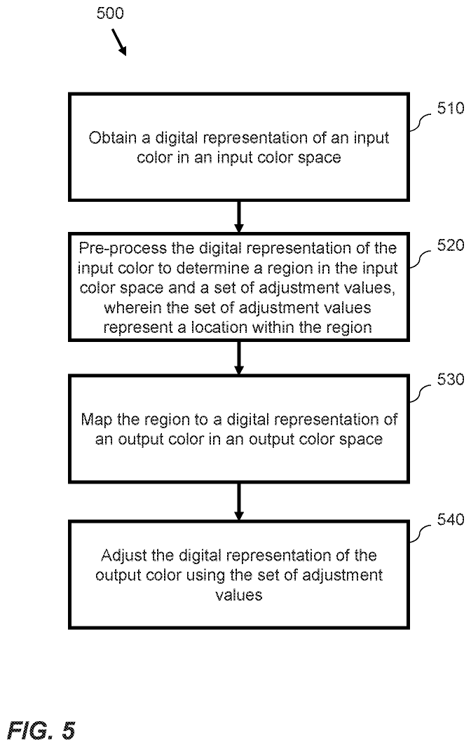

FIG. 5 is a flow chart illustrating a method 500 for converting between color spaces. At block 510, the method 500 comprises obtaining a digital representation of an input color in an input color space. Obtaining the digital representation may comprise receiving the digital representation over a communications channel. The communications channel may be any suitable communications channel for receiving a digital representation of the input color. The communications channel may comprise a wired or wireless communications device. Receiving the digital representation may comprise receiving the digital representation over a network such as a local area network (LAN) or a wide area network (WAN). Alternatively, obtaining the digital representation may comprise obtaining the digital representation from storage, for example by accessing a portion of storage. The portion of storage may be a virtualized portion of storage or may be a physical portion of storage, for example as part of temporary or non-temporary memory, such as Random-Access Memory (RAM), or Read-Only Memory (ROM). The storage may be part of any suitable storage medium including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

At block 520, the method 500 comprises pre-processing the digital representation of the input color to determine a region in the input color space and a set of adjustment values, wherein the set of adjustment values represent a location within the region. As described above, the region may be represented by a node, for example, a multidimensional node. In examples where the input color space comprises three color channels, the regions may be considered as three-dimensional volumes within a three-dimensional coordinate system wherein each axis corresponds to a different one of the three color channels. In such an example, each region may be adjacent to a plurality of other regions. The edges of each region may be constrained by the other regions. For example, each region may be illustrated as a cuboid wherein a respective node representing the region is a vertex of the cuboid. Consequently, each region may be in contact with a plurality of nodes which represent neighboring regions. The set of adjustment values may therefore represent a location in the region for example by representing a vector difference from the vertex of the region which is represented by the node.

At block 530, the method 500 comprises mapping the region to a digital representation of an output color in an output color space. Mapping the region to a digital representation of the output color may comprise accessing a lookup-table which comprises entries associating regions in the input color space to corresponding digital representations of output colors in the output color space. For example, each region may be represented by a node which may be considered as a co-ordinate representing a position in the input color space. In some examples, the nodes define respective vertices of the regions. In other examples, the node may be positioned somewhere within its respective region and the boundaries of the region may defined by a function. The boundary of the region may also be predetermined by manual selection rather than a function. The lookup-table used for mapping regions in the input color space to output colors in the output color space may comprise a plurality of entries each relating a respective node to a digital representation of an output color in the output color space. The lookup-table for mapping regions in the input color space to output colors may be populated using a function. In other examples, the entries may be selected based on a rule, or may be selected based on some other criteria.

At block 540, the method 500 comprises adjusting the digital representation of the output color using the set of adjustment values. In some cases, the digital representation of the input color does not directly correspond to a node representing a region. When the node is mapped to an output color, if the node does not directly correspond to the input color, then the output color may be a poor representation of the input color. The adjustment values represent a difference between the input color and the node that can be used to adjust the digital representation of the output color such that the output color more closely resembles the input color. Adjusting the digital representation of the output color may not include up-sampling. The digital representation of the output color, to which the region is mapped, may comprise output color channel values having a desired resolution for a final output. For example, the mapping may comprise mapping a node, which may effectively be a sub-sampled input color, to a full resolution digital representation of an output color. In this way, artifacts may be prevented, which may generally be introduced when up-sampling.

In some examples, the input color space comprises a plurality of regions and a size of a first region of the plurality of region differs to the size of at least a second region of the plurality of regions. In this way, the resolution of color space conversion may be increased in regions of the input color space which are of particular interest.

FIG. 6 is a schematic diagram illustrating an example input color space 600 comprising two color channels, Channel 1 and Channel 2. The input color space 600 is divided into a plurality of regions 610a-610m and a first region 610a differs in size from at least a second region 610e-610m. Channel 1 and 2 represent different color channels of the example input color space 600. Each channel may be represented by a value from 0 to 255 (in this case as these values may be represented by 8-bit values). The regions, 610a-610d, at the lower end of the range of input color channel values are smaller than regions 610k-610m at the higher end of the range of input color channel values. In examples where the input color space 600 is an additive color space, such that higher values represent increased brightness, then the example of the regions shown in FIG. 6 will result in deceased color space conversion resolution in the brighter areas of the color space 600 and increased resolution in the darker areas of the color space 600. Alternatively, where the color space 600 is a subtractive color space, then the example shown in FIG. 6 represent a region selection which results in greater resolution in the brighter parts of the color space 600 and reduced resolution in the darker parts of the color space 600. The sizes of the regions may be determined based on a function, a selection rule, iterative changes, and/or calibration methods.

In some examples, the region is adjacent to a plurality of regions in the input color space. As shown in FIG. 6, the regions may be directly adjacent with a plurality of further regions, however, in other examples the regions may not be directly adjacent to the further regions. Adjusting the digital representation of the output color may comprise adjusting the digital representation of the output color using digital representations of a plurality of output colors corresponding to the plurality of adjacent regions. For example, where a first region 610f is mapped to a digital representation of an output color, the digital representation of the output color may be adjusted using digital representations of output colors corresponding to regions 610i, 610e, 610j, etc. The digital representations of output colors corresponding to these regions may also be determined by mapping, for example, using mapping circuitry. The digital representations of the output colors corresponding to the adjacent regions may be used in conjunction with the adjustment values to adjust the digital representation of the output color.

In some examples, adjusting the digital representation of the output color comprises generating a set of weights based on the set of adjustment values and interpolating using the set of weights and the digital representations of the plurality of output colors corresponding to the plurality of adjacent regions. As discussed above, the region may be represented by a node, wherein adjacent regions are represented by respective nodes. Each node may be mapped to a respective digital representation of an output color in the output color space. The set of weights may comprise a weight value for each of the plurality of nodes which represent adjacent regions in the input color space. The set of weights may be generated using interpolation methods. For example, generating the set of weights may include a tetrahedral interpolation, trilinear interpolation, sub-cube division, or any other suitable functions. The weights may then be used to interpolate using the digital representations of the plurality of output colors corresponding to the plurality of adjacent regions

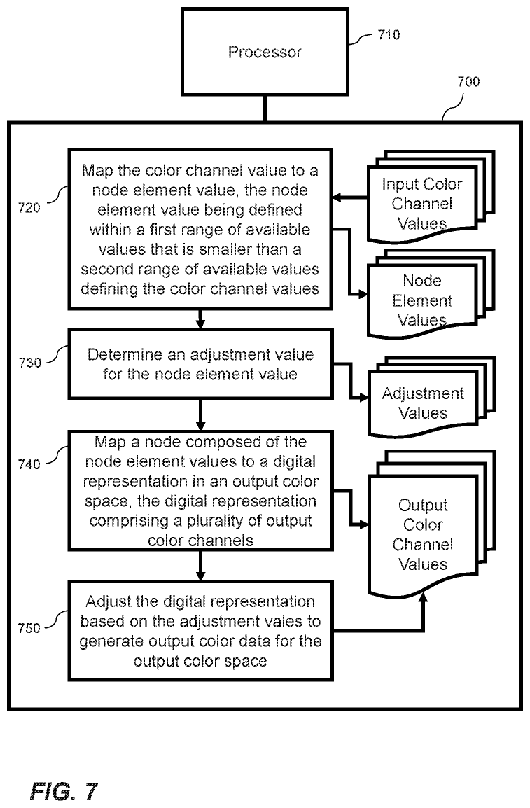

FIG. 7 shows a non-transitory computer-readable storage medium 700 according to an example. The storage medium 700 comprises instructions 720, 730, 740, 750. The instructions 720, 730, 740, 750, may be executed by the at least one processor 710. When executing the instructions shown at block 720 and 730, the at least one processor 710 may be caused to: for each input color channel value in an input color space, map the color channel value to a node element value, the node element value being defined within a first range of available values that is smaller than a second range of available values defining the color channel values; and determine an adjustment value for the node element value. The second range of available values may be determined by the representation of the color channel values. For example, where the color channel values are represented by 8-bit values, the second range may comprise 256 available values. Where the color channel values are expressed using fewer bits, e.g. 6-bit values, in which case the second range may be smaller, e.g. 64 available values. In some examples, the second range may comprise a subset of the possible values which can be expressed using the corresponding digital representation. For example, if the color channel value is represented by an 8-bit value, it may be that only every 5th bit value may be available. The above may also be applied to the first range of available values.

When executing the instructions shown in block 740, the at least one processor 710 may map a node composed of the node element values to a digital representation in an output color space. The digital representation comprises a plurality of output color channel values. Each output color channel value is defined within a third range of available values that is larger than the first range of available values. The digital representation in the output color space may be referred to as a digital representation of an output color. In some examples, the third range of available values is the same size as the second range of the available values.

When executing the instructions shown in block 750, the at least one processor 710 may adjust the digital representation based on the adjustment values to generate output color data for the output color space. Adjusting the digital representation may comprise performing an interpolation. The interpolation may be a function of the adjustment values and data corresponding to a plurality of further digital representations in the output color space.

In some examples, the input color channel value is represented by an n-bit value which is mapped to the node element value based on a rounded division of the input color channel value using a divisor. The divisor may be based on a ratio of a maximum value in the second range of values and the first range of available values. The divisor may be based on a scale difference between a size of the first range of available values and the maximum value of the second range of available values. For example, where the second range of available values comprises integer values between 0 and 255 represented by 8-bit values and the respective color channel is split into 25 regions, i.e. the first range comprises 26 available values, which may also be referred to as available node element values, we can calculate the divisor as follows. The scale difference may be determined based on a maximum available value, e.g. 255, and the number of regions 25, in this example, this is determined as equal to 10.2, as in the example shown in FIG. 2.

The adjustment value for the node element value may be determined using a modulo function which is based on the input color channel value and a modulo factor. In some examples, the modulo factor may be based on a ratio between the maximum value in the second range and the first range of available values. For example, the modulo factor may be based on a scale difference between a size of the first range of available values and the maximum value in the second range of available values.

As will be apparent from the preceding description, the above methods and systems may be applicable to a wide variety of color spaces and color space conversions such as YUV, LAB, etc. The methods and apparatus described herein may be applied to printing systems. In such systems, digital representations of image are often encoded in an RGB format and final outputs of print engines which reproduce images are encoded in a CMYK format. The process may also work in reverse where processing or analysing a printed image, for example when scanning a printed image. In an example, at least one of the input color space or output color space is an RGB color space. In some examples, at least one of the input color space or the output color space is a CMYK color space.

In some examples, the input color channel values are represented by n-bit values having a first bit length and node element values are represented by m-bit values having a second bit length which is shorter than the first bit length. By converting the input color channel values to node element values having a shorter bit-length, and hence fewer potential values, it may be possible to use a mapping operation, for example a lookup-table, which is configured to directly map between nodes, comprising node element values, and digital representations in the output color space. For example, a lookup-table used to map to digital representations in an output color space may comprise an entry for each possible node. It may otherwise be prohibitive to include an entry for every available color in the input color space.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus for converting between color spaces comprising:
pre-processing circuitry to convert a digital representation of an input color in an input color space to a multidimensional node representing a region in the input color space and a set of adjustment values, the set of adjustment values representing a location within the region;
mapping circuitry to map the multidimensional node to a digital representation of an output color in an output color space; and
adjustment circuitry communicatively coupled to the pre-processing circuitry and the mapping circuitry to adjust the digital representation of the output color using the set of adjustment values.

2. The apparatus of claim 1, wherein the mapping circuitry implements a lookup-table comprising entries associating multidimensional nodes representing regions in the input color space with respective digital representations of output colors in the output color space.

3. The apparatus of claim 1, wherein the digital representation of the input color comprises a plurality of input color channel values, and pre-processing is performed per input color channel such that the multidimensional node comprises a respective plurality of node element values.

4. The apparatus of claim 3, wherein the pre-processing circuitry implements a lookup-table per input color channel to map from a respective input color channel value to one or more of a corresponding node element value and a corresponding adjustment value.

5. The apparatus of claim 1, wherein pre-processing an input color channel value comprises:
using a rounded division of the input color channel value with a divisor, the divisor being based on a number of available regions and a maximum input color channel value; and
using a modulo function based on the input color channel function and a modulo factor, the modulo factor being based on the number of available regions and the maximum input color channel value.

6. A method for converting between color spaces comprising:
obtaining a digital representation of an input color in an input color space;
pre-processing the digital representation of the input color to determine a region in the input color space and a set of adjustment values, wherein the set of adjustment values represent a location within the region;
mapping the region to a digital representation of an output color in an output color space; and
adjusting the digital representation of the output color using the set of adjustment values.

7. The method of claim 6, wherein the input color space comprises a plurality of regions and a size of a first region of the plurality of regions differs to a size of at least a second region of the plurality of regions.

8. The method of claim 6, wherein the region is adjacent to a plurality of regions in the input color space and adjusting the digital representation of the output color comprises adjusting the digital representation of the output color using digital representations of a plurality of output colors corresponding to the plurality of adjacent regions.

9. The method of claim 8, wherein adjusting the digital representation of the output color comprises generating a set of weights based on the set of adjustment values and interpolating using the set of weights and the digital representations of the plurality of output colors.

10. A non-transitory computer-readable storage medium storing instructions which, when executed by at least one processor, cause the at least one processor to:
for each input color channel value in an input color space:
map the color channel value to a node element value, the node element value being defined within a first range of available values that is smaller than a second range of available values defining the color channel values, and
determine an adjustment value for the node element value;
map a node composed of the node element values to a digital representation in an output color space, the digital representation comprising a plurality of output color channel values, each output color channel value being defined within a third range of available values that is larger than the first range of available values; and
adjust the digital representation based on the adjustment values to generate output color data for the output color space.

11. The non-transitory computer-readable storage medium of claim 10, wherein the input color channel value is represented by an n-bit value which is mapped to the node element value based on a rounded division of the input color channel value using a divisor, the divisor being based on a ratio of a maximum value in the second range of values and the first range of available values.

12. The non-transitory computer-readable storage medium of claim 11, wherein the adjustment value for the node element value is determined using a modulo function based on the input color channel value and a modulo factor, the modulo factor being based on the ratio of the maximum value in the second range of values and the first range of available values.

13. The non-transitory computer-readable storage medium of claim 10, wherein at least one of the input color space or the output color space is an RGB color space.

14. The non-transitory computer-readable storage medium of claim 10, wherein at least one of the input color space or the output color space is a CMYK color space.

15. The non-transitory of computer-readable storage medium of claim 10, wherein the input color channel values are represented by n-bit values having a first bit length and the node element values are represented by m-bit values having a second bit length which is shorter than the first bit length.
